(19) United States
(12) Patent Application Publication
(10) Pub. No.: US 2016/0172004 A1
(43) Pub. Date: Jun. 16, 2016

(54) VIDEO CAPTURING APPARATUS

(71) Applicant: Panasonic Intellectual Property Management Co., Ltd., Osaka (JP)

(72) Inventors: Yoshihiro MORIOKA, Nara (JP); Kenji MATSUURA, Nara (JP); Hiroyuki KAMEZAWA, Osaka (JP); Osafumi MORIYA, Osaka (JP); Hideaki HATANAKA, Kyoto (JP); Eiji YAMAUCHI, Osaka (JP)

(21) Appl. No.: 15/049,746

(22) Filed: Feb. 22, 2016

Related U.S. Application Data
(63) Continuation of application No. PCT/JP2014/006452, filed on Dec. 25, 2014.

(30) Foreign Application Priority Data
Jan. 7, 2014 (JP) 2014-000736

(51) Int. Cl. G11B 27/10; G06K 9/00; H04N 9/87; H04N 5/77

(52) U.S. Cl. CPC G11B 27/10; H04N 5/772; G06K 9/00744; H04N 9/87

(57) ABSTRACT

A video capturing apparatus includes imaging unit, generator, detector, storage unit, assigning unit, and output unit. The generator generates time information for the captured video. The detector detects a predetermined video feature from the captured videos. The storage unit stores the captured videos, the time information, and the video features, with the captured videos being associated with the time information and the video features. The assigning unit assigns tag information to either the video having an evaluated value for the video feature that is larger than a predetermined value or the video having a change amount of the video feature that is larger than a predetermined value. The output unit preferentially outputs a video, of the captured videos, to which the tag information is assigned, when the captured videos are output. This configuration allows the video capturing apparatus capable of playing back a digest of videos.

### BACKGROUND

1. Technical Field

The present disclosure relates to video capturing apparatuses to capture and output videos and, more particularly, to a video capturing apparatus capable of performing digest playback.

2. Description of the Related Art

Conventionally, video capturing apparatuses have been known which are capable of evaluating captured videos based on their metadata, and of automatically performing digest playback of them, when playing back the photographed videos.

Japanese Domestic Republication WO2010/116715 discloses that, in such a video capturing apparatus, a video region is highly valued which has metadata including a human face, a human voice, and camera work in a zoom-in or still-state mode. Such a video region is preferentially output when the digest reproduction is performed.

### SUMMARY

A video capturing apparatus according to the present disclosure includes an imaging unit, a generator, a detector, a storage unit, and an assigning unit. The generator generates time information capable of specifying a timewise position in a video captured by the imaging unit. The detector sections the video captured by the imaging unit into video regions of predetermined units of time based on the time information, and detects on a per video region basis, from a combination of a change pattern of a camera work and a change pattern of the video, attribute information about a predetermined action, the change pattern of the camera work being acquired from attitude information of the apparatus in itself. The storage unit stores, on a per video region basis, the attitude information and the time information, the attitude information being associated with the time information. The assigning unit assigns tag information to one of the following two regions of the video regions. One is a video region which has an evaluated value for the attribute information about the predetermined action, with the evaluated value being larger than a predetermined value. The other is a video region which has a change amount of the attribute information about the predetermined action, with the change amount being larger than a predetermined value. The tag information indicates that the video region to which the tag information is assigned has a video feature.

With this configuration, the video capturing apparatus capable of playing back a digest of videos is provided.

### BRIEF DESCRIPTION OF DRAWINGS

FIG. 1 is an external perspective view of a video camera according to the present disclosure;

FIG. 2 is a diagrammatic view of a hardware configuration of the inside of the video camera according to the present disclosure;

FIG. 3 is a view of a functional configuration of the video camera according to the present disclosure;

FIG. 4 is a schematic view of an example of attribute information which is generated by a generator according to the present disclosure;

FIG. 5 is a view illustrating an example of an evaluation value list for the attribute information on predetermined video features, according to the present disclosure;

FIG. 6 is a view illustrating another example of the evaluation value list for the attribute information on the predetermined video features, according to the present disclosure; and

FIG. 7 is a view illustrating an example of an evaluation value list for attribute information on predetermined video features in another mode, according to the present disclosure.

### DETAILED DESCRIPTION

Hereinafter, detailed descriptions of embodiments will be made with reference to the accompanying drawings as deemed appropriate. However, descriptions in more detail than necessary will sometimes be omitted. For example, detailed descriptions of well-known items and duplicate descriptions of substantially the same configuration will sometimes be omitted, for the sake of brevity and easy understanding by those skilled in the art. It is noted that the present inventors provide the accompanying drawings and the following descriptions so as to facilitate fully understanding of the present disclosure by those skilled in the art. The inventors in no way intend for the present disclosure to impose any limitation on the subject matter described in the appended claims.

### First Exemplary Embodiment

[1-1. Configuration]

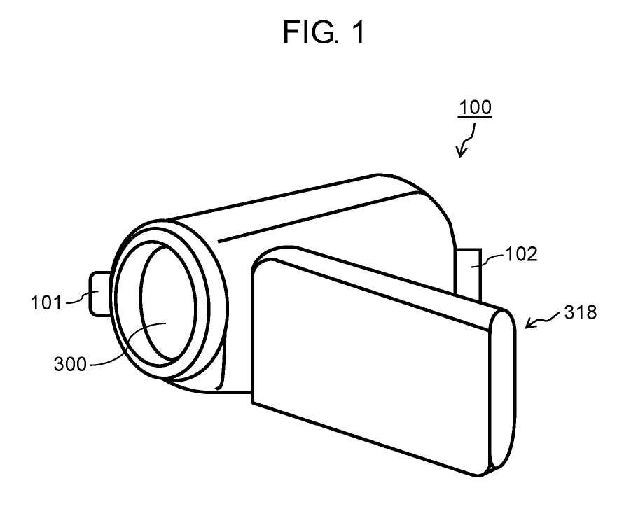

A configuration of video camera 100 will be described as a specific example of a video capturing apparatus according to the present disclosure, with reference to FIG. 1. FIG. 1 is an external perspective view of video camera 100. Video camera 100 includes battery 101, grip belt 102, imaging unit 301 (not shown) to capture videos, display unit 318 to display the videos captured by imaging unit 301; detail descriptions of them will be made later. Imaging unit 301 is configured with a complementary metal oxide semiconductor (C-MOS) sensor (not shown) and the like to convert incident light from lens unit 300 into a video signal. Display unit 318 is configured with a touch panel-type liquid crystal display.

### [1-1. Hardware Configuration]

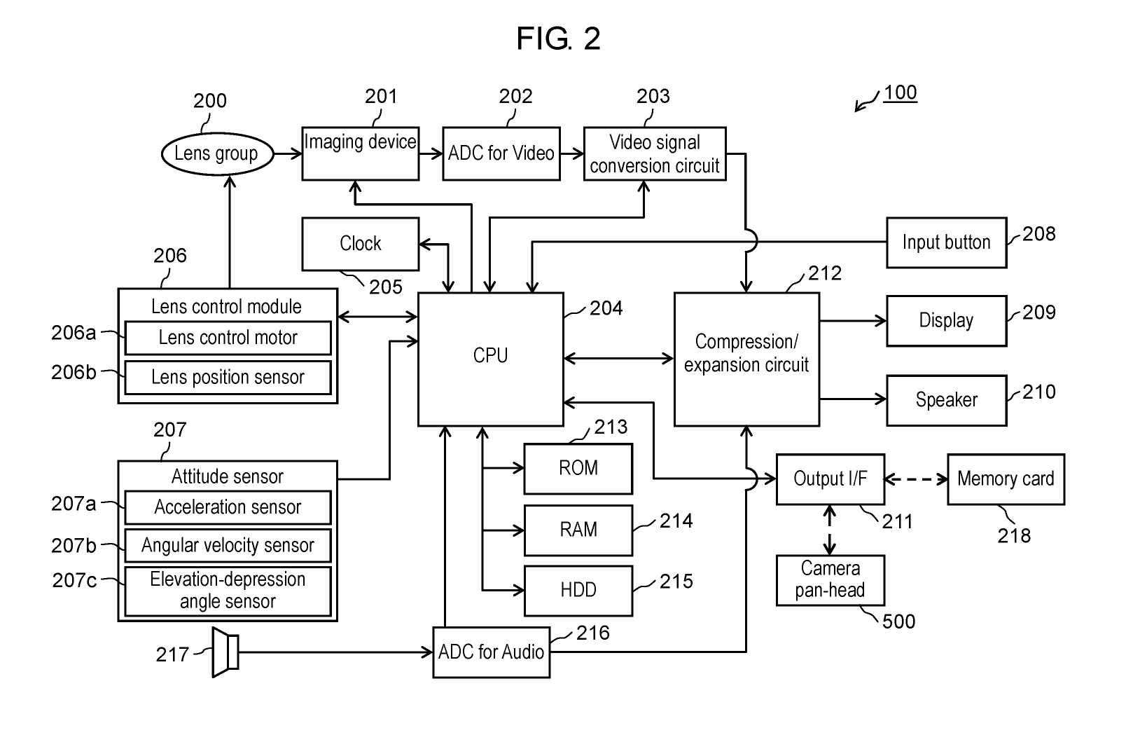

FIG. 2 is a diagrammatic view of a hardware configuration of the inside of video camera 100. Video camera 100 includes the following constituent elements: That is, lens group 200, imaging device 201, analog-to-digital converter (ADC) for video 202, video signal conversion circuit 203, central processing unit (CPU) 204, clock 205, lens control module 206, attitude sensor 207, input button 208, display 209, speaker 210, output Interface (I/F) 211, compression/expansion circuit 212, read only memory (ROM) 213, random access memory (RAM) 214, hard disk drive (HDD) 215, analog-to-digital converter (ADC) for audio 216, and stereo microphone 217.

Lens group 200 adjusts incident light from a subject to form a subject image on imaging device 201. Specifically, lens group 200 adjusts a focal length and a zoom (a magnification rate of video) by changing distances between a plurality of lenses with various characteristics. These adjustments may be either manually performed by a user of video camera 100 or automatically performed via lens control module 206 under control by CPU 204 and the like, to be described later.

Imaging device 201 converts the light incident through lens group 200 into an electric signal. Imaging device 201 may employ an image sensor, such as a charge coupled device (CCD) or a C-MOS sensor.

ADC for video 202 converts the analog electric signal, which is fed from imaging device 201, into a digital electric signal. The digital signal thus-converted by ADC for video 202 is output to video signal conversion circuit 203.

Video signal conversion circuit 203 converts the digital signal, which is fed from ADC for video 202, into a video signal in a predetermined system, such as the National Television System Committee (NTSC) system, the Phase Alternating Line (PAL) system, or the like.

CPU 204 controls the whole of video camera 100. Among modes of the control is, for example, lens control for controlling the incident light on imaging device 201, which is performed through the aforementioned control of both the focal length of lenses and the zoom via lens control module 206. Moreover, the modes include input-control for controlling external inputs from input button 208, attitude sensor 207, and the like, and operation-control of compression/expansion circuit 212. CPU 204 executes software or the like to perform control algorithms of these control modes.

Clock 205 outputs a clock signal to CPU 204 and the like which operates in video camera 100, with the clock serving as a reference for their processing. Note that clock 205 may employ either a single clock or a plurality of clocks, depending both on data to be treated and on integrated circuits which use the clock(s). Moreover, it is possible to use any of multiples of the clock generated by a single oscillator.

Lens control module 206 detects a state of lens group 200, and causes each lens of lens group 200 to operate in accordance with the control by CPU 204. Lens control module 206 is equipped with lens control motor 206a and lens position sensor 206b, which is a sensor for detecting lens position.

Lens position sensor 206b detects directions, positional relations, and the like between the plurality of the lenses that configures lens group 200. The positional information and the like between the plurality of the lenses, thus-detected by lens position sensor 206b, is transmitted to CPU 204. CPU 204 transmits, to lens control motor 206a, a control signal to properly arrange the plurality of the lenses based on the information both from lens position sensor 206b and from other constituent elements such as imaging device 201.

Lens control motor 206a is a motor to drive the lenses based on the control signal transmitted from CPU 204. This allows changes of the relative positional relation between the plurality of the lenses of lens group 200, for adjusting the focal length of the lenses and the zoom. With this configuration, the incident light having passed through lens group 200 is caused to form a targeted subject image on imaging device 201.

Note that, besides the aforementioned operation, CPU 204 may detect a hand shaking of video camera 100 during capturing by using lens position sensor 206b, attitude sensor 207 to be described later, or the like, which thereby performs the control of the driving of lens control motor 206a. With such a configuration, CPU 204 is also allowed to perform an image stabilization against hand shaking via lens control module 206.

Attitude sensor 207 detects a state of the attitude of video camera 100. Attitude sensor 207 is equipped with acceleration sensor 207a, angular velocity sensor 207b, and elevation-depression angle sensor 207c, which is a sensor for detecting elevation-depression angles. These various kinds of sensors allow CPU 204 to detect a state of capturing process of video camera 100. Note that these sensors are preferably capable of detecting the attitude in each of three axial directions (such as a vertical direction and horizontal directions), thereby detecting the detailed attitude of video camera 100.

Input button 208 is one of the input interfaces operated by a user of video camera 100. The use of input button 208 allows the user to input, into video camera 100, user's various requirements such as a start or end of shooting, insertion of a marking into an image during the video capturing, and the like. Moreover, display 209 to be described later may serve as a touch panel which configures a part of the functions of input button 208.

Display 209 is disposed so that the user can view a video being captured with video camera 100, stored videos, and the like. Display 209 allows the user to check to make sure the just-captured video on the spot. In addition to the above operation, display 209 is allowed to display various kinds of information of video camera 100, thereby informing the user of more detailed information about the capturing process, the video capturing apparatuses, and the like.

Speaker 210 is used to output a sound when the captured video is played back. Besides this, speaker 210 can also be used to sound a warning to inform the user of the warning given by video camera 100.

Output I/F 211 is used to output the video captured by video camera 100 to the external apparatuses, and to output a control signal to control the operation of camera pan-head 500 to be described later. Specifically, output I/F 211 includes, a cable interface for connecting the external apparatuses with cables, a memory card interface for storing the captured videos into mobile memory card 218, and the like. Outputting of the captured videos via output I/F 211 allows the user to view, such as, the captured videos on an external display larger in size than display 209 that is installed in video camera 100.

Compression/expansion circuit 212 converts the captured videos and sounds into digital data in a predetermined format (coding process). Specifically, compression/expansion circuit 212 converts (compresses) the data of the captured-video and -sound into ones in the predetermined format in compliance with the Moving Picture Experts Group (MPEG) standard, the H.264 standard, or the like. Moreover, when the captured data are played back, compression/expansion circuit 212 expands the compressed video data in the predetermined format, and performs data processing of the data to display them on display 209 or the like. It is noted, however, that compression/expansion circuit 212 may also have a function of compression/expansion of still images as well as the videos.

ROM 213 stores both programs of software executed by CPU 204 and various kinds of data for operating the programs.

RAM 214 is used as a memory area and the like which is used in executing the programs of the software by CPU 204. Moreover, the CPU may share RAM 214 with compression/expansion circuit 212.

HDD 215 is used to accumulate, such as, the videos and still images both encoded by compression/expansion circuit 212. Note that, other than the aforementioned data, the accumulated data may include playback information and the like to be described later. Moreover, the description is made using HDD 215 as a typical memory medium; however, a semiconductor memory device may be used instead of it.

ADC for audio 216 converts the sound fed from stereo microphone 217, from an analog electric signal into a digital electric signal.

Stereo microphone 217 converts the sound from the exterior of video camera 100 into the electric signal, and outputs the resulting signal.

As described above, the configuration of the hardware of video camera 100 has been illustrated; however, the present invention is not limited to this configuration. For example, it is possible to implement the configuration by employing a single integrated circuit. In addition, a part of the software programs executed by CPU 204 may be separately provided via hardware such as a field programmable gate array (FPGA).

### [1-1-2. Functional Configuration]

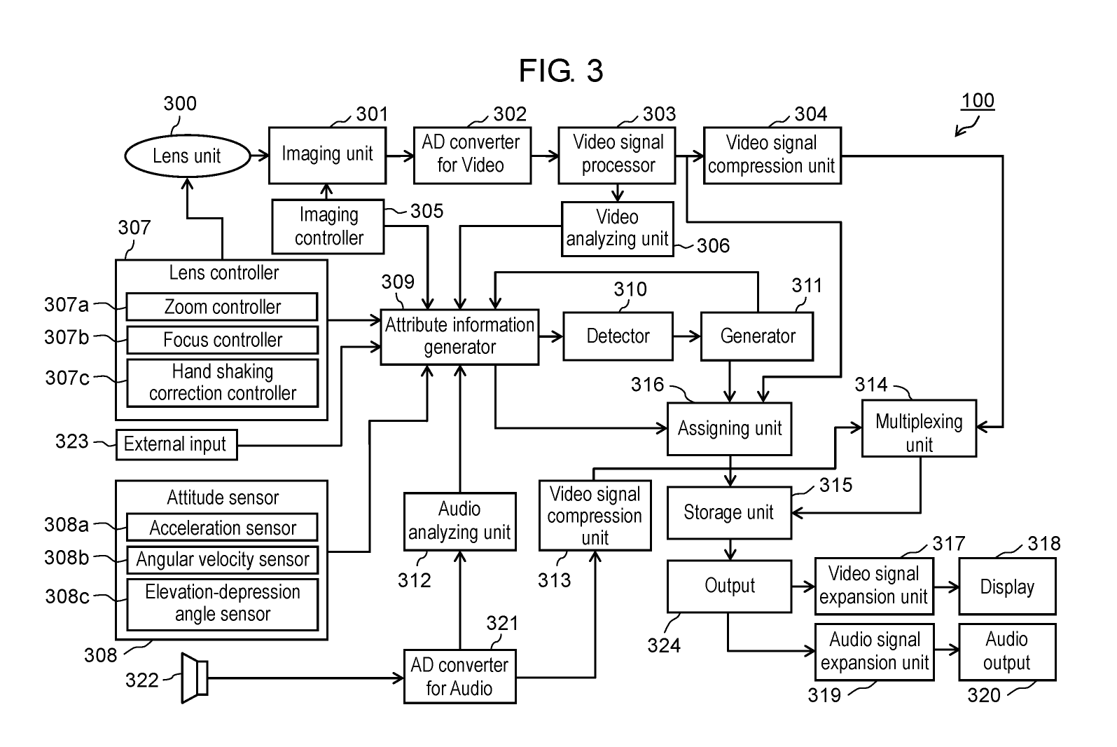

FIG. 3 is a detailed view of a functional configuration of video camera 100 shown in FIG. 1.

Video camera 100 includes the following functional constituent elements, as shown in FIG. 3: That is, lens unit 300, imaging unit 301, AD converter for video 302, video signal processor 303, video signal compression unit 304, imaging controller 305, video analyzing unit 306, lens controller 307, attitude sensor 308, attribute information generator 309, detector 310, generator 311, audio analyzing unit 312, audio signal compression unit 313, multiplexing unit 314, storage unit 315, imparting unit 316, video signal expansion unit 317, display unit 318, audio signal expansion unit 319, audio output 320, AD converter for audio 321, microphone 322, external input 323, and output unit 324.

Lens unit 300 adjusts a focal length and a zoom magnification (a magnification rate of video) for the light incident from a subject. These adjustments are controlled by lens controller 307. Lens unit 300 corresponds to lens group 200 shown in FIG. 2.

Imaging unit 301 converts the light having passed through lens unit 300 into an electric signal. Imaging unit 301outputs data fed from an optional area of the imaging device, under the control by imaging controller 305. Other than the video data, the imaging unit can also output information on other items including: information about chromaticity space of position of three primary color, coordinates of white color, gains of at least two of the three primary colors, color temperature, Δuv (delta uv), and gamma information of the three primary colors or a luminance signal. The information on these items is output to attribute information generator 309. Imaging unit 301 corresponds to imaging device 201 shown in FIG. 2.

AD converter for video 302 converts the electric signal from imaging unit 301, from the analog electric signal to a digital electric signal in accordance with a predetermined procedure. AD converter for video 302 corresponds to ADC for video 202 shown in FIG. 2.

Video signal processor 303 converts the digital signal, which is fed from AD converter for video 302, into a video signal in a predetermined format. For example, the thus-converted video signal is in conformity with the NTSC standard, in terms of the number of horizontal lines, the number of scanning lines, and a frame rate. Video signal processor 303 corresponds to video signal conversion circuit 203 shown in FIG. 2.

Video signal compression unit 304 performs a predetermined coding-conversion of the digital signal that has processed by video signal processor 303, allowing the compression and the like of the amount of the data. Specifically, the coding-conversion is performed with a coding method including the MPEG-2, MPEG-4, and H.264 standards. Video signal compression unit 304 corresponds to compression/expansion circuit 212 shown in FIG. 2.

Imaging controller 305 controls the operation of imaging unit 301. Specifically, imaging controller 305 controls imaging unit 301, concerning an exposure value, a capturing rate per second, sensitivity, and the like in capturing. Moreover, the control information on these items is output to attribute information generator 309 as well. Imaging controller 305 is implemented by adopting one of the control algorithms executed by CPU 204 shown in FIG. 2.

Video analyzing unit 306 extracts video features from the video signal of the captured video.

The video is configured with an object and a background. Among the objects are, for example, persons, animals such as pets, furniture, household utensils, clothes, housings, cars, bicycles, and motorcycles. Changes of the video are changes of the objects and background in the video, which include: changes of shapes, textures (patterns), and/or positions of the persons and articles in the video; and changes of shapes, textures, and/or positions of the background in the video. Moreover, the video features include: features of shapes, textures (patterns with colors), and/or sizes of the objects and background in the video; and features of chronological changes of the objects and background in the video. The changes of the video can also be detected by a server on a cloud network as well as video analyzing unit 306 in the apparatus.

In the embodiment, the video features are extracted by analyzing the video signal in terms of items including: luminance and color information of the video, a motion vector, white balance, face information of a person in cases of the face appearing in the video. The luminance and color information can be obtained, for example, by dividing a display area of the video into 576 blocks, horizontal 32×longitudinal 18, and calculating a distribution of the luminance and colors of the blocks. The motion vectors can be obtained by calculating differences in quantities of the features between a plurality of frames. The detection of the face information can be performed by pattern matching or the like of the quantities of the features, through learning the quantities which can express characteristics of the face concerned. Video analyzing unit 306 is implemented by adopting one of the algorithms of the software executed by CPU 204 shown in FIG. 2. Likewise, the detection of persons and articles can be performed in the same way, i.e. by pattern matching and pattern learning of their features.

Lens controller 307 controls operations of zooming, focusing, and the like of lens unit 300. Lens controller 307 includes zoom controller 307a, focus controller 307b, and hand shaking correction controller 307c.

Zoom controller 307a controls the zoom lens of lens unit 300 so as to magnify the light incident from a subject by a desired magnification rate, and then inputs the magnified light to imaging unit 301. Focus controller 307b sets the focal length from imaging unit 301 to the subject by controlling the focus lens of lens unit 300. Hand shaking correction controller 307c suppresses hand shaking of the apparatus when the video is captured. Lens controller 307 controls lens unit 300 and outputs the information on these items to attribute information generator 309. Lens controller 307 corresponds to lens control module 206 shown in FIG. 2.

Attitude sensor 308 detects acceleration, an angular velocity, an elevation-depression angle, and the like of video camera 100. Attitude sensor 308 includes acceleration sensor 308a, angular velocity sensor 308b, and elevation-depression angle sensor 308c. These sensors are used to detect the attitude of video camera 100, the changes in attitude, and the like. Regarding the acceleration and the angular velocity, the sensors are preferably capable of detecting them in three directions, i.e. a vertical direction and two horizontal directions. Attitude sensor 308 corresponds to attitude sensor 207 shown in FIG. 2.

Microphone 322 converts sounds collected from the surroundings into an electric signal, and outputs it as an audio signal. Microphone 322 corresponds to stereo microphone 217 shown in FIG. 2.

AD converter for audio 321 converts the analog electric signal fed from microphone 322 into a digital electric signal. AD converter for audio 321 corresponds to ADC 216 for audio shown in FIG. 2.

Audio analyzing unit 312 extracts distinct sounds from the audio data that have been converted to the digital electric signal. Here, the distinct sounds include, for example, a voice of the photographer, a sound of a specific word, loud cheers, and a sound of gunfire. These sounds can be extracted by distinguishing them among the other sounds in such a manner or the like where frequencies of these sounds (voices) are compared with their inherent frequencies that have been registered in advance. Moreover, besides the above items, audio analyzing unit 312 detects other features such as input levels of the sounds collected by microphone 322. Audio analyzing unit 312 is implemented by adopting one of the algorithms of the software executed by CPU 204 shown in FIG. 2.

Audio signal compression unit 313 converts the audio data fed from AD converter for audio 321, by using a predetermined coding algorithm. The coding method includes the MPEG Audio Layer-3 (MP3) standard and the Advanced Audio Coding (AAC) standard. Audio signal compression unit 313 is implemented by adopting one of the compression functions of compression/expansion circuit 212 shown in FIG. 2.

Multiplexing unit 314 multiplexes the coded video data fed from video signal compression unit 304 and the coded audio data fed from audio signal compression unit 313, and then outputs the result. Multiplexing unit 314 may be either software executed by CPU 204 shown in FIG. 2 or hardware included in compression/expansion circuit 212.

External input 323 outputs various kinds of information received from the outside as the video is captured. Such information includes, for example, input-via-button information from the photographer and capturing-index information received via communications from the outside. Note that the capturing-index information includes an identification number to identify each of the capturing operations, in terms of capturing scenes, the number of capturing times, and the like as the video is captured. External input 323 corresponds to attitude sensor 308 and the like shown in FIG. 2.

Attribute information generator 309 generates attribute information, which is information about attribute, for a video region of a predetermined unit of time (e.g. 2 seconds); the attribute information includes the capturing information in capturing the video or still image, external input information, and other information. Examples of the information included in the attribute information are as follows:

focal length

zoom magnification rate

exposure

capturing speed (frame rate, shutter speed,)

sensitivity

information about chromaticity space of position of three primary color

white balance

information about gains of at least two of the three primary colors

information about color temperature

Δuv (delta uv)

gamma information of the three primary colors or a luminance signal

color distribution

motion vector

person (face recognition, personal authentication by face, personal recognition, and personal authentication by gait)

camera attitude (acceleration, angular velocity, elevation-depression angle, orientation, positional data of GPS, and the like)

capturing time (start time and end time of capturing)

capturing index (e.g. set-up values of capturing mode of camera)

user's input

frame rate

sampling frequency

amount of change in composition of an image

The attribute information also includes the information that characterizes a video region which is calculated from the information listed above (where the video-characterizing information is obtained by combining the various kinds of the information as the capturing is made and by analyzing the resulting combination). Moreover, the attribute information also includes the information on a plurality of attribute items of the video region. Note that the video region as referred herein is a time region that is a synonym of a period.

Specifically, from the information about the camera attitude (acceleration, an angular velocity, an elevation-depression angle, and the like), it is possible to obtain the information on pan, tilt, and the like of camera work of video camera 100 during capturing. Moreover, the information on the focal length and the zoom magnification rate can be used as the attribute information, even as they are. From the various kinds of information during the capturing, attribute information generator 309 either extracts or calculates information useful for the evaluation of the video region, thereby generating the attribute information, such as the positional information of a person, person's face, a moving object, and a sound.

Detector 310 detects, in each of the video regions, the attribute information concerning the video features useful for digest playback, based on the attribute information generated by attribute information generator 309. Such video features include: camera work of zoom-in, zoom-out, pan, tilt, or still; the presence or absence of a person (a moving object) who is sensed via the face detection and the motion vectors; the presence or absence of a specific color (a color of a finger or gloves, for example); a sound of a human voice and the like; and either magnitude of the motion vectors or an amount of changes of the motion vectors. Attribute information generator 309 and detector 310 are each implemented by adopting one of the algorithms of the software executed by CPU 204 shown in FIG. 2.

Generator 311 generates time information, which is information about time, in synchronization with the video being captured. The time information generated by generator 311 makes it possible to specify a timewise position of the captured video in each of the video regions. Moreover, based on the time information, attribute information generator 309 sections the video captured by imaging unit 301 into video regions on predetermined units of time, and generates the attribute information for each of the sectioned video regions. Generator 311 corresponds to clock 205 shown in FIG. 2.

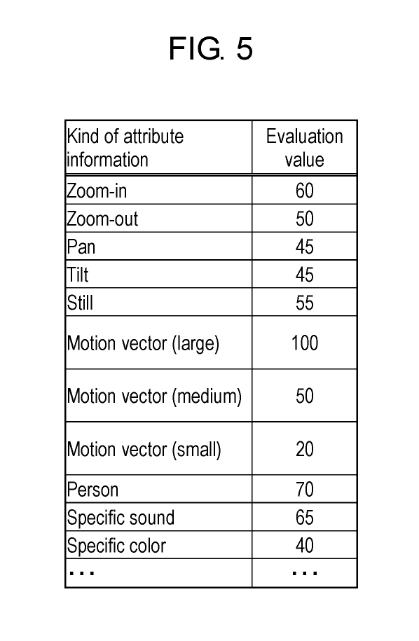

Assigning unit 316 assigns tag information, which is information about a tag, to a video region, which is specified among the video regions, having the video features detected by detector 310. The tag information indicates that such a tag-assigned video region has a video feature, with the evaluated value and/or the change amount of the video feature being larger than respective predetermined threshold values. The tag information serves as a mark when the digest playback is performed. The assigning of the tag information is performed in the following manner, although details of this will be described later: Values for video features are calculated in each of the video regions, based on predetermined evaluation values for the video features as shown in FIG. 5. Among the video regions, a video region is specified when it has a large evaluated value and/or a large change amount, and then the specified video region is assigned with the tag information. The change amount as referred herein is a difference in evaluated values between the images (still images) of at least two of the frames configuring the video (moving image). Assigning unit 316 is implemented by adopting one of the algorithms of the software executed by CPU 204 shown in FIG. 2.

On a per video region basis, storage unit 315 stores, temporarily or long-term, the coded video data and the coded audio data fed from multiplexing unit 314, the time information fed from generator 311, and the attribute information concerning the video features fed from detector 310, with the thus-stored data and information being associated with each other. In addition, the tag information fed from assigning unit 316 as well is more preferably stored. Storage unit 315 corresponds to HDD 215, RAM 214, memory card 218, or the like shown in FIG. 2.

Output unit 324 preferentially outputs the video region with the tag information assigned by assigning unit 316, among the video regions captured by imaging unit 301. The function of the digest playback may be performed either in accordance with user's instruction or automatically.

### [1-2. Operation]

### [1-2-1. Operation Mode]

In the case where a user's instruction is provided, for example, the operation modes may be configured to be selectable by the instruction between an action mode (first mode) in which a video containing large action is mainly output and a static mode (second mode) in which a video captured by slowly-moving camera work is mainly output. In this case, the modes can be configured to be selectable not only by the user's instruction but also by changing the evaluated values for the attribute information on the predetermined video features to be referred when the tag information is assigned.

In the action mode, output unit 324 can output mainly the videos containing large action scenes which are captured from the viewpoint of an athlete or captured by a cameraman actively moving due to an unexpected incident, for example. On the other hand, in the static mode, output unit 324 can output mainly the videos which are captured with slowly-moving camera work in situations, such as, where an object e.g. a specific person is followed, for example.

In the case where a mode is automatically selected in outputting the video, such a automatic selection can be implemented, for example, by adopting an algorithm or the like including the following procedure: That is, assigning unit 316 compares the evaluated values for the attribute information obtained via the evaluation in the action mode to those obtained via the evaluation in the static mode, over the whole of the captured video. Based on the result of the comparison, the assigning unit selects one mode from the modes such that variations in the evaluated values for highly-rated attribute information are smaller in the one mode than those in the other mode.

Output unit 324 is implemented by adopting one of the algorithms of the software executed by CPU 204 shown in FIG. 2.

### [1-2-2. Action Mode]

The action mode will be described in detail. In the action mode, not all of the captured videos are played back. Instead, videos are extracted and played back which mainly contain large action scenes that are captured from the viewpoint of an athlete or captured by a cameraman actively moving due to an unexpected incident, for example.

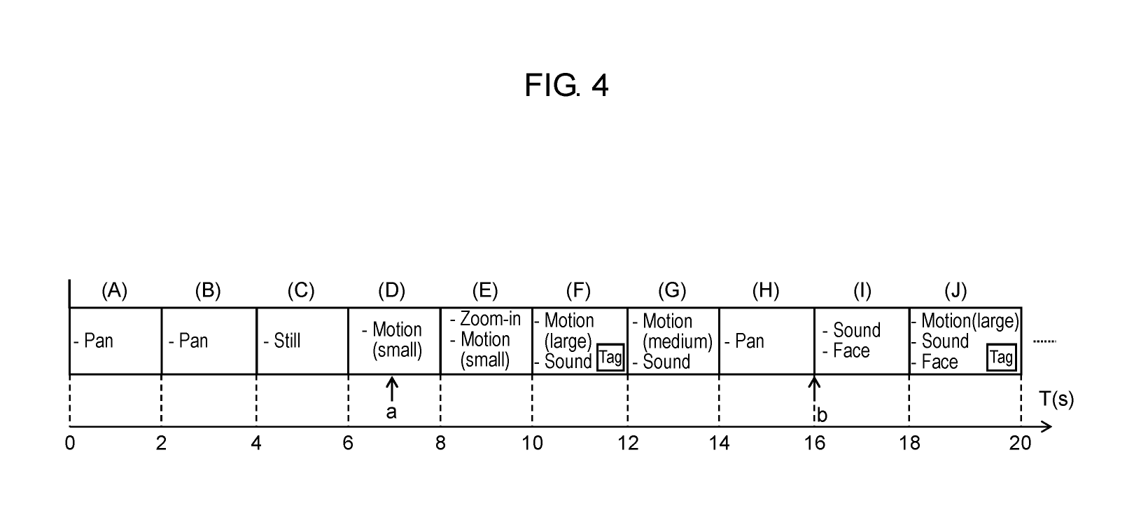

FIG. 4 is a view of an example of attribute information on predetermined video features, which is fed from attribute information generator 309. Attribute information generator 309 detects the attribute information on the predetermined video features that are contained in a video region of a predetermined unit of time. In the presence of a plurality of video features and the like, the attribute information is detected on each of the plurality of the video features.

FIG. 4 shows the case where the predetermined time unit is 2 seconds, the video lasting for 20 seconds after the start of capturing is composed of 10 video regions (A) to (J), and the attribute information is detected in each of the video regions. Moreover, in video regions of (F) and (J), the video information on a predetermined video feature is detected and tags are assigned to some of the regions.

As described above, detector 310 detects the attribute information on the predetermined video features useful for digest playback, based on the attribute information generated by attribute information generator 309. Such predetermined video features include: camera work of zoom-in, zoom-out, pan, tilt, or still; the presence or absence of a person (a moving object) who is sensed via the face detection and the motion vectors; the presence or absence of a specific color (a color of a finger or gloves, for example); a sound of a human voice and the like; and magnitude of the motion vectors or an amount of changes of the motion vectors. In the action mode, either the magnitude of the motion vectors or the change amount of the motion vectors is important. In FIG. 4, the tags are assigned to video regions (F) and (J) in which the attribute information of “motion (large)” is detected which relates to the video feature of large magnitude of the motion vector.

Moreover, the action detection can be performed in such a manner that: The detection is made concerning a change pattern of the camera work, a change pattern of the video, and a combination of both the patterns. Then, the result of the detection is compared with references, i.e. a pre-registered change pattern of camera work and a pre-registered change pattern of video, thereby determining the action of the video concerned. For example, in the detection of the change pattern of the camera work and the change pattern of the video, the more the number of times of the evaluation of these change patterns is, the higher the accuracy of the action detection becomes. Moreover, a practical action detection which requires only a small amount of computation can be performed by comparing the detected patterns with three to five past-detected patterns which were detected at a point in time prior to the current detection. For example, consider a case where the change pattern is such that the state of camera work changes in the sequence: (1) still state for 3 seconds, (2) abrupt motion for 1 second, and (3) still state for 3 seconds. When such change patterns are observed, state (2) will be detected as an action pattern. In addition to this process, an additional process results in an increased accuracy of the action detection, which is as follows: The video images and sounds during the period of this change pattern are analyzed and compared with predetermined patterns of a video image and a sound. Then, only if the analyzed images and sounds are in agreement with the predetermined patterns, the current action detection is determined to be correct.

Assigning unit 316 evaluates the attribute information on the predetermined video features detected by detector 310. FIG. 5 shows an example of an evaluation value list for the attribute information on the predetermined video features in the action mode. As shown in FIG. 5, the evaluation value list is composed of the attribute information and its evaluation values. The evaluation values are set such that, the greater the attention paid to the video feature is, the larger the evaluation value is. In FIG. 5, the largest evaluation value of 100 is assigned to the “motion vector (large)”, which indicates that such a video region featuring the motion is highly evaluated.

Assigning unit 316 evaluates each of the video regions based on the evaluation value list, that is, through use of the evaluation values in the list for the attribute information detected in the each of the video regions. When the attribute information on a plurality of the attributes is detected, the evaluation is made basically using the information on the attribute with the highest evaluation value among the plurality of the attributes. However, the evaluation may be made using a sum of the evaluation values for the plurality of the attributes, or alternatively made using an average of the evaluation values for the plurality of the attributes.

Assigning unit 316 assigns the tag information to the video regions to which high evaluated values are given. Moreover, when a difference in evaluated values is large between two adjacent video regions, the tag information is assigned to both the video regions.

When the digest playback is performed, output unit 324 preferentially outputs the video region to which the tag information is assigned. In this case, output unit 324 may start to output the video at the point in time that is predetermined time (e.g. 3 seconds) prior to the video region to which the tag information is assigned. Specifically, in the case shown in FIG. 4 where the tag information is assigned to video region (F), the output is started at point “a”, i.e. at T=7 that is 3 seconds earlier to the region.

Moreover, when the video region prior to the video region assigned with the tag information contains the attribute information on such as a person and/or a sound including a human voice, output unit 324 may start to output the video at the point in time of the beginning of the video region having the attribute information on the person and/or the sound. Specifically, as shown in FIG. 4, video region (I) prior by one to video region (J) assigned with the tag information has the attribute information on a person and a sound. Accordingly, the video is output starting from the point “b” (T=16) that is the beginning of video region (I).

With this operation, the output is started not suddenly with the video containing the large action. Instead, it may be started with a prologue to the video, which allows the viewer to see, for example, circumstances of the occurrence of such large action.

### [1-3. Advantage and Others]

Video camera 100 according to the first embodiment includes the first mode and the second mode. In the first mode, the video camera preferentially outputs the video region, among the video regions, which has the evaluated value for the attribute information, with the evaluated value being larger than a predetermined value. Also, in the first mode, the video camera preferentially outputs a plurality of the video regions, among chronological strings of the video regions, which offers a difference in the change of the attribute information between the preferentially-output video regions, with the difference being larger than a predetermined value. In the second mode, the video camera preferentially outputs a video region, among the video regions, which is stored and associated with the attribute information on the video features that relate to a person, a specific camera work, a specific sound, or a specific color. In a selected one of the modes, assigning unit 316 assigns the tag information to the video region to be preferentially output.

With this configuration, for example, the operation mode can be configured to be selectable between the action mode (first mode) in which the video containing large action is mainly output and the static mode (second mode) in which the video captured by slowly-moving camera work is mainly output. Moreover, when outputting the videos, output unit 324 preferentially outputs the video region to which the tag information is assigned.

Therefore, it is possible to output the video regions having video features. That is, the digest playback of dynamic videos is possible.

Moreover, output unit 324 starts the output with the video region that has the time information concerning the point in time prior, by a predetermined time, to the point in time at which the video region to be preferentially output begins.

Furthermore, in the presence of the video region having the video feature of a person or a sound with the video region being prior to the beginning of the video region to be preferentially output, output unit 324 starts the output with the video region having the video feature of the person or the sound.

With this operation, the output can be started not suddenly with the video containing large action, but started with a prologue to the video concerned. In addition, this allows the viewer to see, such as, circumstances of the occurrence of such large action.

### Second Exemplary Embodiment

### [2-1. Operation]

A function of an action mode according to a second embodiment will be described in which attitude information from attitude sensor 308 is also used. The configuration of video camera 100 according to the embodiment is the same as that according to the first embodiment; therefore, an explanation of the duplicate parts thereof is omitted.

Detector 310 detects attribute information on predetermined video features useful for digest playback, based on attribute information generated by attribute information generator 309. Such predetermined video features include: magnitude of an elevation-depression angle from the horizontal attitude being as a reference; an amount of change in the elevation-depression angle; or magnitude of acceleration and an angular velocity, in addition to the aforementioned features, i.e. camera work of zoom-in, zoom-out, pan, tilt, or still; the presence or absence of a person (a moving object) who is sensed via face detection and motion vectors; the presence or absence of a specific color (a color of a finger or gloves, for example); a sound of a human voice and the like; and magnitude of the motion vectors or change amount of the motion vectors. Assigning unit 316 evaluates the attribute information detected by detector 310.

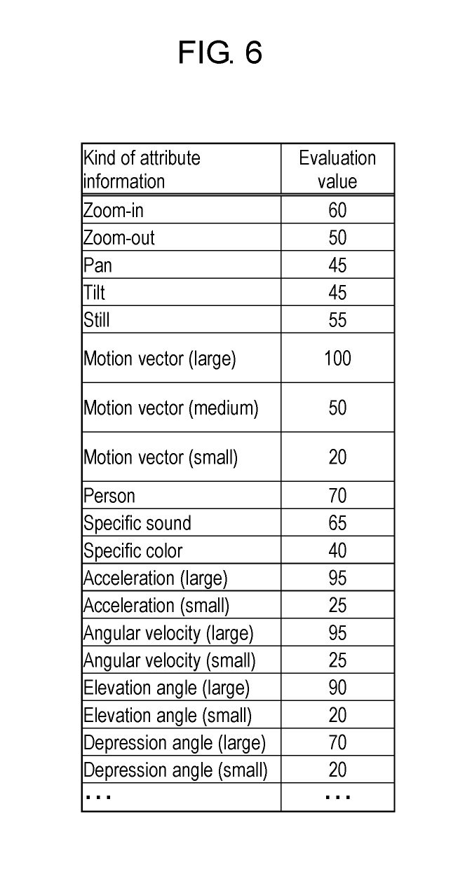

FIG. 6 is a view of an example of an evaluation value list for the attribute information, including the attitude information as well, on the predetermined video features in the action mode. In FIG. 6, for example, items from “acceleration (large)” to “elevation angle (small)” are the attitude information included in the attribute information on the predetermined video features.

Assigning unit 316 performs the evaluation in the same manner as in the first embodiment, and assigns tag information to the video regions to which high evaluation values are given. Moreover, when a difference in change of the evaluated values is large between the two adjacent video regions, the tag information is assigned to both the video regions.

When digest playback is performed, output unit 324 preferentially outputs the video region to which the tag information is assigned. At this time, output unit 324 may start to output the video at a point in time prior, by a predetermined time, to the video region assigned with the tag information, in the same manner as in the first embodiment. Moreover, when a video region prior to the video region assigned with the tag information contains the attribute information on such as a person and/or a sound including a human voice, output unit 324 may start to output the video at the point in time of the beginning of the video region having the attribute information on the person and/or the sound.

With this operation, the output can be started not suddenly with the video containing large action, but started with a prologue to the video. In addition, this allows the viewer to see, such as, circumstances of the occurrence of such large action.

### [2-2. Advantage and Others]

In video camera 100 according to the second embodiment, the predetermined video features include the attitude information of the camera in itself. Assigning unit 316 assigns the information to the video region specified among the video regions. Such a specified video region is either one in which the evaluated value for the attribute information concerning predetermined attitude information is larger than a predetermined value or one in which the amount of change in the attribute information concerning the predetermined attitude information is larger than a predetermined value.

With this configuration, use of the attitude information of video camera 100 allows the detection of the video regions containing large motions.

Therefore, the digest playback of videos is possible.

### Other Exemplary Embodiments

As described above, the first and second embodiments have been described to exemplify the technology disclosed in the present application. However, the technology is not limited to these embodiments, and is also applicable to embodiments that are subjected, as appropriate, to various changes and modifications, replacements, additions, omissions, and the like. Moreover, the technology disclosed herein also allows another embodiment which is configured by combining the appropriate constituent elements in the first and second embodiments described above.

Given these circumstances, other exemplary embodiments will be described hereinafter.

(A) In the embodiments described above, although the descriptions have been made using the case of handy-type video camera 100, the technology disclosed herein is not limited to the case. The technology is also applicable to wearing-type cameras, so-called wearable cameras.

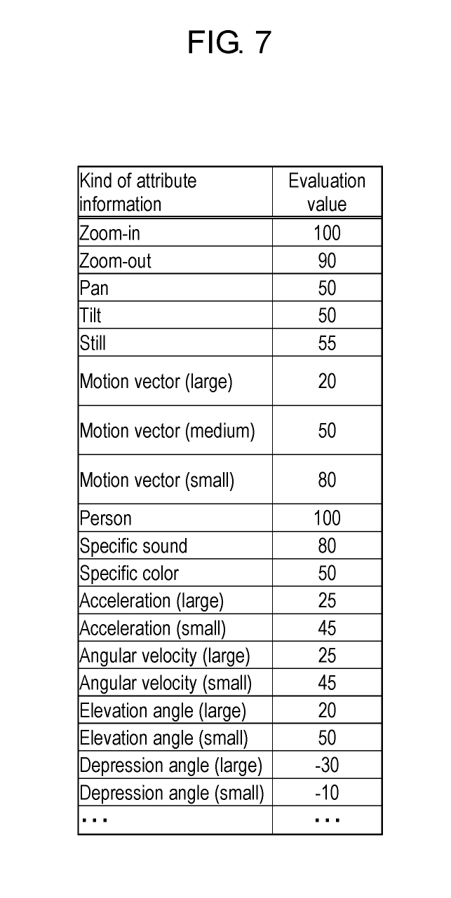

(B) In the embodiments described above, the descriptions have been made using the example of the evaluation value list for the video features in the action mode. However, in the static mode, an evaluation value list as shown in FIG. 7 may be preferably used. In FIG. 7, the evaluation value list includes the video feature of a person, and a higher evaluation value is given for this video feature than those for the other video features. By using such a list, the output of the videos can be performed focusing on the videos photographed by slowly-moving camera work, such as camera work to follow a specific person. Moreover, other evaluation lists suitable for other modes may be further included.

(C) Searching of the videos may be performed using information in which the video regions are associated with the time information, the attribute information, and the tag information. In this configuration, the thus-associated information may be output to other apparatuses via a network.

(D) In the embodiments described above, the descriptions have been made using the case where the attribute information is used to extract video regions for the digest reproduction; however, the attribute information may also be used in other applications. For example, the attribute information may be applied to a still camera so that the shutter can be released when the video shows no motion. In this case, such an operation can be implemented by assigning the tag information to the motionless video region.

As described above, the exemplary embodiments and modified ones have been described to exemplify the technology according to the present disclosure. To that end, the accompanying drawings and the detailed descriptions have been provided.

Therefore, the constituent elements described in the accompanying drawings and the detailed descriptions may include not only essential elements for solving the problems, but also inessential ones for solving the problems which are described only for the exemplification of the technology described above. For this reason, it should not be acknowledged that these inessential elements are considered to be essential only on the grounds that these inessential elements are described in the accompanying drawings and/or the detailed descriptions.

Moreover, because the aforementioned embodiments are used only for the exemplification of the technology disclosed herein, it is to be understood that various changes and modifications, replacements, additions, omissions, and the like may be made to the embodiments without departing from the scope of the appended claims or the scope of their equivalents.

The technology according to the present disclosure can be applicable to, such as, wearable cameras capable of capturing videos from the viewpoint of an athlete, and to common video cameras as well when the output of videos is performed focusing on videos featuring large action.

What is claimed is:

1. A video capturing apparatus comprising:
an imaging unit;
a generator generating time information capable of specifying a timewise position in a video captured by the imaging unit;
a detector sectioning the video captured by the imaging unit into video regions of predetermined units of time based on the time information, and detecting on a per video region basis, from a combination of a change pattern of camera work and a change pattern of the video, attribute information about a predetermined action, the change pattern of the camera work being acquired from attitude information of the apparatus in itself;
a storage unit storing, on a per video region basis, the attribute information and the time information, the attribute information being associated with the time information; and
an assigning unit assigning tag information to one of
a video region, of the video regions, having an evaluated value for the attribute information about the predetermined action, the evaluated value being larger than a predetermined value, and
a video region, of the video regions, having a change amount of the attribute information about the predetermined action, the change amount being larger than a predetermined value, the tag information indicating that the video region assigned with the tag information has a video feature.

2. A video capturing apparatus comprising:
a imaging unit;
a generator generating time information capable of specifying a timewise position in a video captured by the imaging unit;
a detector sectioning the video captured by the imaging unit into video regions of predetermined units of time based on the time information, and detecting on a per video region basis attribute information about a predetermined video feature;
a storage unit storing, on a per video region basis, the attribute information and the time information, the attribute information being associated with the time information; and
an assigning unit including a first mode and a second mode,
wherein, in the first mode, the assigning unit assigns tag information to one of
a video region, of the video regions, having an evaluated value for the attribute information, the evaluated value being larger than a predetermined value, and
a plurality of the video regions, of chronological strings of the video regions, having a change amount of the attribute information, the change amount being larger than a predetermined value, the tag information indicating that the video region assigned with the tag information has the video feature; and,
in the second mode, the assigning unit assigns the tag information to a video region, of the video regions, being stored and associated with the attribute information about the video feature concerning a person, specific camera work, and one of a specific sound and a specific color.

3. The video capturing apparatus according to claim 1, wherein the assigning unit assigns the tag information to one of
a video region, of the video regions, having the evaluated value for the attribute information, the evaluated value being larger than the predetermined value, and
a plurality of the video regions, of chronological strings of the video regions, having an amount of a change of the attribute information, the amount being larger than a predetermined value.

4. The video capturing apparatus according to claim 2,
wherein the assigning unit compares the evaluated value for the predetermined video feature evaluated in the first mode to the evaluated value for the predetermined video feature evaluated in the second mode;
the unit selects one, of the modes, exhibiting less variations in an highly-evaluated value of the evaluated values than the other; and
the unit assigns the tag information to the video region in the selected mode.

5. The video capturing apparatus according to claim 1, further comprising an output unit preferentially outputting the video region assigned with the tag information when the video captured by the imaging unit is output.

6. The video capturing apparatus according to claim 2, further comprising an output unit preferentially outputting the video region assigned with the tag information when the video captured by the imaging unit is output.

7. The video capturing apparatus according to claim 3, further comprising an output unit preferentially outputting the video region assigned with the tag information when the video captured by the imaging unit is output.

8. The video capturing apparatus according to claim 4, further comprising an output unit preferentially outputting the video region assigned with the tag information when the video captured by the imaging unit is output.

9. The video capturing apparatus according to claim 5, wherein the output unit starts outputting with the video region having the time information tracing back by a predetermined time from a timewise position at which the video region to be preferentially output begins.

10. The video capturing apparatus according to claim 6, wherein the output unit starts outputting with the video region having the time information tracing back by a predetermined time from a timewise position at which the video region to be preferentially output begins.

11. The video capturing apparatus according to claim 7, wherein the output unit starts outputting with the video region having the time information tracing back by a predetermined time from a timewise position at which the video region to be preferentially output begins.

12. The video capturing apparatus according to claim 8, wherein the output unit starts outputting with the video region having the time information tracing back by a predetermined time from a timewise position at which the video region to be preferentially output begins.

13. The video capturing apparatus according to claim 5, wherein, when the video region having a specific video feature concerning one of a parson and a sound is present prior to a timewise position at which the video region to be preferentially output begins, the output unit starts outputting with the video region in which the video containing the specific video feature begins.

14. The video capturing apparatus according to claim 6, wherein, when the video region having a specific video feature concerning one of a parson and a sound is present prior to a timewise position at which the video region to be preferentially output begins, the output unit starts outputting with the video region in which the video containing the specific video feature begins.

15. The video capturing apparatus according to claim 7, wherein, when the video region having a specific video feature concerning one of a parson and a sound is present prior to a timewise position at which the video region to be preferentially output begins, the output unit starts outputting with the video region in which the video containing the specific video feature begins.

16. The video capturing apparatus according to claim 8, wherein, when the video region having a specific video feature concerning one of a parson and a sound is present prior to a timewise position at which the video region to be preferentially output begins, the output unit starts outputting with the video region in which the video containing the specific video feature begins.
